(19) United States
(12) Patent Application Publication
(10) Pub. No.: US 2024/0267083 A1
(43) Pub. Date: Aug. 8, 2024

(54) DETECTION APPARATUS, DETECTION METHOD, AND DETECTION PROGRAM

(71) Applicant: Sumitomo Electric Industries, Ltd., Osaka-shi, Osaka (JP)

(72) Inventors: Masato IZAWA, Osaka-shi, Osaka (JP); Satoru SAKURAZAWA, Osaka-shi, Osaka (JP); Isao KATO, Osaka-shi, Osaka (JP); Takumi ASAINA, Osaka-shi, Osaka (JP)

(73) Assignee: Sumitomo Electric Industries, Ltd., Osaka-shi, Osaka (JP)

(21) Appl. No.: 18/290,306

(22) PCT Filed: Feb. 8, 2022
(86) PCT No.: PCT/JP2022/004795

§ 371 Date: Nov. 13, 2023

(30) Foreign Application Priority Data
May 14, 2021 (JP) 2021-082440

(51) Int. Cl. H04B 3/493; H04B 3/23; H04B 3/487

(52) U.S. Cl. CPC H04B 3/493; H04B 3/235; H04B 3/487

(57) ABSTRACT

A detection apparatus is provided for a signal transmission apparatus, the signal transmission apparatus being configured to receive a reception signal via a transmission line and including an adaptive filter to be applied to the reception signal. The detection apparatus includes an acquisition unit configured to acquire a filter coefficient of the adaptive filter, and a detection unit configured to detect an abnormality in the transmission line, based on an amount of change over time in the filter coefficient acquired by the acquisition unit.

### TECHNICAL FIELD

The present disclosure relates to a detection apparatus, a detection method and a detection program. This application claims priority based on Japanese Patent Application No. 2021-82440 filed on May 14, 2021, and the entire contents of the Japanese patent application are incorporated herein by reference.

### BACKGROUND

PTL 1 discloses a relay apparatus having a function of detecting disconnection of a signal line included in a communication cable.

### PRIOR ART DOCUMENT

### Patent Literature

PTL 1: Japanese Unexamined Patent Application Publication No. 2018-142862

### SUMMARY OF THE INVENTION

A detection apparatus of the present disclosure is provided for a signal transmission apparatus. The signal transmission apparatus is configured to receive a reception signal via a transmission line and includes an adaptive filter to be applied to the reception signal. The detection apparatus includes an acquisition unit configured to acquire a filter coefficient of the adaptive filter, and a detection unit configured to detect an abnormality in the transmission line, based on an amount of change over time in the filter coefficient acquired by the acquisition unit.

A detection method of the present disclosure in a detection apparatus is provided for a signal transmission apparatus. The signal transmission apparatus is configured to receive a reception signal via a transmission line and includes an adaptive filter to be applied to the reception signal. The detection method includes acquiring a filter coefficient of the adaptive filter, and detecting an abnormality in the transmission line, based on an amount of change over time in the acquired filter coefficient.

A detection program of present disclosure is used in a detection apparatus provided for a signal transmission apparatus. The signal transmission apparatus is configured to receive a reception signal via a transmission line and includes an adaptive filter to be applied to the reception signal. The detection program causes a computer to function as an acquisition unit configured to acquire a filter coefficient of the adaptive filter, and a detection unit configured to detect an abnormality in the transmission line, based on an amount of change over time in the filter coefficient acquired by the acquisition unit.

### BRIEF DESCRIPTION OF THE DRAWINGS

FIG. 1 is a diagram showing an example of a configuration of a communication system according to an embodiment of the present disclosure.

FIG. 2 is a diagram showing another example of a configuration of a communication system according to an embodiment of the present disclosure.

FIG. 3 is a diagram showing an example of a configuration of a signal transmission apparatus in a communication system according to an embodiment of the present disclosure.

FIG. 4 is a diagram showing an example of a configuration of a baseline wander corrector in a signal transmission apparatus according to an embodiment of the present disclosure.

FIG. 5 is a diagram showing an example of a configuration of an equalizer in the signal transmission apparatus according to an embodiment of the present disclosure.

FIG. 6 is a diagram showing an example of a configuration of an echo canceller in the signal transmission apparatus according to an embodiment of the present disclosure.

FIG. 7 is a diagram showing an example of a configuration of a detection apparatus according to an embodiment of the present disclosure.

FIG. 8 is a diagram showing an example of time-series data in a storage unit of a detection apparatus according to an embodiment of the present disclosure.

FIG. 9 is a diagram showing another example of time-series data in a storage unit of a detection apparatus according to an embodiment of the present disclosure.

FIG. 10 is a diagram showing another example of time-series data in a storage unit of a detection apparatus according to an embodiment of the present disclosure.

FIG. 11 is a diagram showing a time constant of each variable filter unit and detection sensitivity to various abnormalities in a detection apparatus according to an embodiment of the present disclosure.

FIG. 12 is a diagram showing a correspondence relationship between a determination result regarding a filter coefficient and a result of detection processing in the detection processing of the detection apparatus according to an embodiment of the present disclosure.

FIG. 13 is a flowchart showing an example of an operation procedure when the detection apparatus according to an embodiment of the present disclosure performs the detection processing.

### DETAILED DESCRIPTION

### Problems to be Solved by Present Disclosure

Conventionally, a technique for detecting an abnormality of a transmission line has been developed.

A technique capable of detecting the abnormality in a transmission line more accurately than the technique described in PTL 1 is desired.

The present disclosure has been made in view of the problems as described above. The present disclosure provides a detection apparatus, a detection method, and a detection program capable of detecting the abnormality in a transmission line more accurately.

### Advantageous Effects of Present Disclosure

According to the present disclosure, the abnormality in a transmission line can be detected more accurately.

An aspect of the present disclosure may be implemented as a semiconductor integrated circuit that implements a part or all of the detection apparatus, or may be implemented as a detection system including the detection apparatus.

### Description of Embodiments of Present Disclosure

First, the contents of embodiments of the present disclosure will be listed and described.

(1) A detection apparatus according to an embodiment of the present disclosure is provided for a signal transmission apparatus. The signal transmission apparatus is configured to receive a reception signal via a transmission line and includes an adaptive filter to be applied to the reception signal. The detection apparatus includes an acquisition unit configured to acquire a filter coefficient of the adaptive filter, and a detection unit configured to detect an abnormality in the transmission line, based on an amount of change over time in the filter coefficient acquired by the acquisition unit.

With such a configuration, it is possible to detect the abnormality in the transmission line based on the amount of change over time (tendency of change) of the filter coefficient, and thus it is possible to detect the abnormality in the transmission line early and accurately compared to a configuration in which the temporal change of the filter coefficient is simply used, even in a case where the change of the filter coefficient is minute. Therefore, it is possible to more accurately detect the abnormality in the transmission line.

(2) The acquisition unit may be configured to acquire filter coefficients of a plurality of adaptive filters for a single transmission line, the filter coefficient being one of the filter coefficients, the adaptive filter being one of the plurality of adaptive filters, the single transmission line being the transmission line. The detection unit may be configured to detect an abnormality in the transmission line, based on an amount of change over time in each of the filter coefficients acquired by the acquisition unit.

With such a configuration, it is possible to more accurately detect various abnormalities in the transmission line based on the amount of change over time of the filter coefficients of the plurality of adaptive filters.

(3) The plurality of adaptive filters may have time constants different from each other.

Depending on the type of the abnormality that has occurred, the changes detected in the amount of change over time of the filter coefficient for each time constant of the adaptive filter are different. With this configuration, it is possible to estimate the type of the abnormality that has occurred based on the amount of change over time of the filter coefficient of each adaptive filter.

(4) The acquisition unit may be configured to acquire filter coefficients of a plurality of taps, of the adaptive filter, for a single transmission line, the filter coefficient being one of the filter coefficients, the single transmission line being the transmission line. The detection unit may be configured to detect an abnormality in the transmission line, based on an amount of change over time in each of the filter coefficients acquired by the acquisition unit.

With such a configuration, various abnormalities in the transmission line can be detected more accurately based on the amount of change over time of the filter coefficient of the tap unit.

(5) The detection unit may be configured to perform both detection of an abnormality in the transmission line based on an amount of change over time in the filter coefficient in an increasing direction and detection of an abnormality in the transmission line based on an amount of change over time in the filter coefficient in a decreasing direction.

As described above, various abnormalities in the transmission line can be detected more accurately by the configuration for monitoring both the increasing tendency and the decreasing tendency of the filter coefficient.

(6) The acquisition unit may be configured to acquire, as the filter coefficient of the adaptive filter, a filter coefficient of at least one of a baseline wander correction, an equalizer, and an echo canceller.

(7) The acquisition unit may be configured to acquire, as the filter coefficients of the plurality of adaptive filters, three filter coefficients of a baseline wander correction, an equalizer, and an echo canceller.

(8) The detection unit may be configured to determine that the transmission line has an abnormality in response to determining that at least two filter coefficients are determined to have abnormal values among the three filter coefficients acquired by the acquisition unit.

With such a configuration, it is possible to more accurately detect an abnormality in a transmission line by using filter coefficients of various adaptive filters for correcting a reception signal.

(9) The detection unit may be configured to determine that the transmission line is abnormal if the number of differences satisfying an abnormality determination condition is a predetermined value or more, and determine that the transmission line is normal if the number of differences satisfying the abnormality determination condition is less than the predetermined value. The abnormality determination condition may be determined using a threshold for the amount of change over time.

As described above, various abnormalities in the transmission line can be detected more accurately by the configuration in which the abnormality determination is performed by using the abnormality determination condition.

(10) A detection method according to an embodiment of the present disclosure in a detection apparatus is provided for a signal transmission apparatus. The signal transmission apparatus is configured to receive a reception signal via a transmission line and includes an adaptive filter to be applied to the reception signal. The detection method includes acquiring a filter coefficient of the adaptive filter, and detecting an abnormality in the transmission line, based on an amount of change over time in the acquired filter coefficient.

With such a method, it is possible to detect the abnormality in the transmission line based on the amount of change over time (tendency of change) of the filter coefficient, and thus it is possible to detect the abnormality in the transmission line early and accurately compared to a configuration in which the temporal change of the filter coefficient is simply used, even in a case where the change of the filter coefficient is minute. Therefore, it is possible to more accurately detect the abnormality in the transmission line.

(11) A detection program according to an embodiment of the present disclosure is used in a detection apparatus provided for a signal transmission apparatus. The signal transmission apparatus is configured to receive a reception signal via a transmission line and includes an adaptive filter to be applied to the reception signal. The detection program causes a computer to function as an acquisition unit configured to acquire a filter coefficient of the adaptive filter, and a detection unit configured to detect an abnormality in the transmission line, based on an amount of change over time in the filter coefficient acquired by the acquisition unit.

With such a configuration, it is possible to detect the abnormality in the transmission line based on the amount of change over time (tendency of change) of the filter coefficient, and thus it is possible to detect the abnormality in the transmission line early and accurately compared to a configuration in which the temporal change of the filter coefficient is simply used, even in a case where the change of the filter coefficient is minute. Therefore, it is possible to more accurately detect the abnormality in the transmission line.

Hereinafter, embodiments of the present disclosure will be described with reference to the drawings. Note that the same or corresponding parts in the drawings are denoted by the same reference numerals, and description thereof will not be repeated. Further, at least some of the embodiments described below may be arbitrarily combined.

### [Configuration and Basic Operation]

### [Communication System]

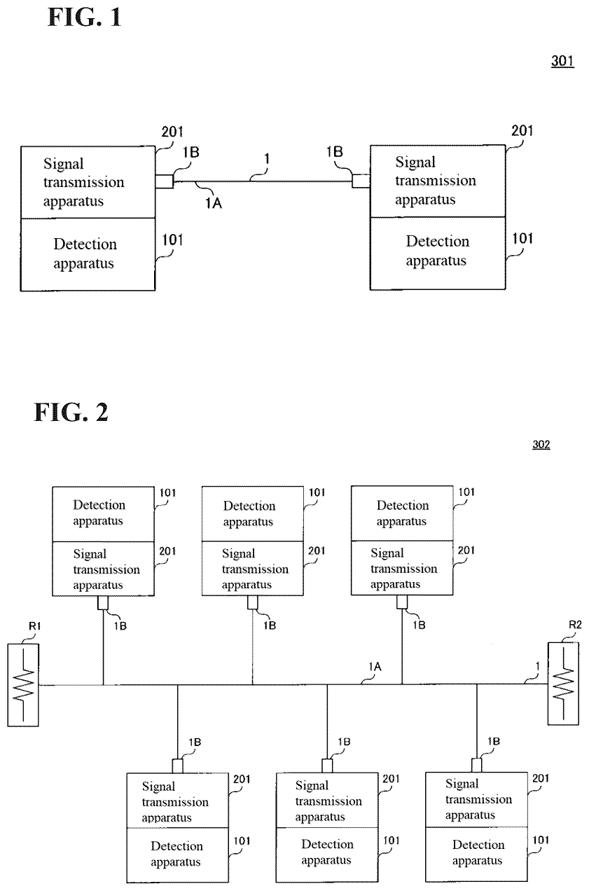

FIG. 1 is a diagram showing an example of a configuration of a communication system according to an embodiment of the present disclosure. Referring to FIG. 1, a communication system 301 includes two signal transmission apparatuses 201 and two detection apparatuses 101. The network topology of communication system 301 is, for example, a line-type network topology.

Two signal transmission apparatuses 201 are connected to each other via a transmission line 1. Transmission line 1 is, for example, an Ethernet (registered trademark) cable. Transmission line 1 includes a cable portion 1A and connector portions 1B respectively provided at a first end and a second end of cable portion 1A. Connector portion 1B is connected to a connector portion (not shown) in signal transmission apparatus 201. Signal transmission apparatus 201 transmits and receives signals via transmission line 1.

Detection apparatus 101 is provided corresponding to signal transmission apparatus 201. More specifically, detection apparatus 101 is connected to signal transmission apparatus 201. Detection apparatus 101 detects the abnormality in transmission line 1.

Communication system 301 may include three or more signal transmission apparatuses 201 and three or more detection apparatuses 101. In this case, the network topology of communication system 301 is, for example, a star-type network topology. More specifically, signal transmission apparatus 201 functioning as a relay apparatus is connected to the plurality of signal transmission apparatuses 201 via transmission line 1.

FIG. 2 is a diagram showing another example of a configuration of a communication system according to an embodiment of the present disclosure. Referring to FIG. 2, a communication system 302 includes six signal transmission apparatuses 201 and six detection apparatuses 101. The network topology of communication system 302 is, for example, a bus-type network topology.

Signal transmission apparatus 201 is connected to a plurality of (the remaining five) signal transmission apparatuses 201 via transmission line 1. Transmission line 1 is, for example, a bus conforming to the CAN (Controller Area Network) standard. Transmission line 1 includes cable portion 1A including a plurality of branch lines, and connector portion 1B provided at an end of each branch line. Connector portion 1B is connected to a connector portion (not shown) in signal transmission apparatus 201. A first end of cable portion 1A is connected to a terminal resistor R1, and a second end thereof is connected to a terminal resistor R2. Signal transmission apparatus 201 transmits and receives signals via transmission line 1.

Detection apparatus 101 is provided corresponding to signal transmission apparatus 201. More specifically, detection apparatus 101 is connected to signal transmission apparatus 201. Detection apparatus 101 detects the abnormality in transmission line 1.

Communication system 302 may configured to include two, three, four, five, or seven or more signal transmission apparatuses 201.

Also, communication systems 301 and 302 may include a smaller number of detection apparatuses 101 than the number of signal transmission apparatuses 201. In this case, at least one of the plurality of signal transmission apparatuses 201 may not be connected to detection apparatus 101.

Communication systems 301 and 302 are mounted on a vehicle, for example. Communication system 301,302 may be used for a home network or factory automation.

In communication systems 301 and 302, signal transmission apparatus 201 is a PLC (Programmable Logic Controller), a vehicle-mounted ECU (Electronic Control Unit), an actuator, or a sensor. The vehicle-mounted ECU functions as, for example, a control device that controls the actuator based on the measurement result of the sensor.

### [Signal Transmission Apparatus]

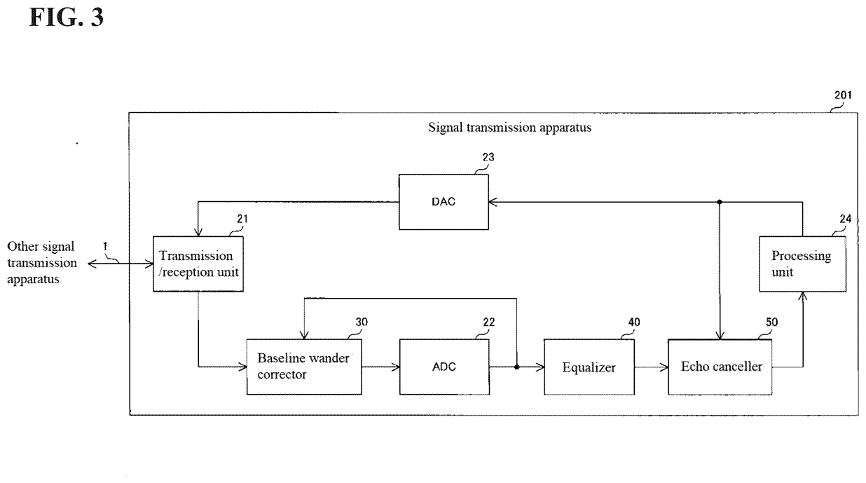

FIG. 3 is a diagram showing an example of a configuration of a signal transmission apparatus in a communication system according to an embodiment of the present disclosure. Referring to FIG. 3, signal transmission apparatus 201 includes a transmission/reception unit 21, an ADC (Analog-to-Digital Converter) 22, a DAC (Digital-to-Analog Converter) 23, a processing unit 24, a baseline wander corrector 30, an equalizer 40, and an echo canceller 50. Baseline wander corrector 30, equalizer 40 and echo canceller 50 are examples of adaptive filters to be applied to the reception signal. Transmission/reception unit 21 is connected to transmission/reception unit 21 in other signal transmission apparatus 201 via transmission line 1.

Processing unit 24 generates various kinds of information to be transmitted to other signal transmission apparatus 201, and outputs a digital signal including the generated information to DAC 23 and echo canceller 50.

DAC 23 converts the digital signal received from processing unit 24 into an analog signal and outputs the analog signal to transmission/reception unit 21.

Transmission/reception unit 21 transmits the analog signal received from DAC 23 to other signal transmission apparatus 201 via transmission line 1.

In addition, transmission/reception unit 21 receives an analog signal from other signal transmission apparatus 201 via transmission line 1 and outputs the received analog signal to baseline wander corrector 30.

Baseline wander corrector 30 corrects the analog signal received from transmission/reception unit 21. More specifically, the analog signal received by transmission/reception unit 21 from other signal transmission apparatus 201 may include a deviation of a baseline due to a DC component and a low frequency component, that is, a deviation of a DC offset. For example, baseline wander corrector 30 receives a digital signal from ADC 22 and corrects the analog signal received from transmission/reception unit 21 by using the received digital signal as a reference signal in order to reduce a deviation of a baseline in the analog signal received by transmission/reception unit 21 from other signal transmission apparatus 201, as will be described later. Baseline wander corrector 30 outputs the corrected analog signal to ADC 22. Details of baseline wander corrector 30 will be described later.

ADC 22 converts the analog signal received from baseline wander corrector 30 into a digital signal and outputs the digital signal to baseline wander corrector 30 and equalizer 40.

Equalizer 40 corrects the digital signal received from ADC 22. More specifically, a high-frequency component of the analog signal received by transmission/reception unit 21 from other signal transmission apparatus 201 may be attenuated depending on the length of transmission line 1 or the like. For example, equalizer 40 performs correction to increase the level of the high frequency band of the signal waveform represented by the digital signal received from ADC 22 in order to compensate for the attenuation of the analog signal in transmission line 1. Equalizer 40 outputs the corrected digital signal to echo canceller 50. Details of equalizer 40 will be described later.

Echo canceller 50 corrects the digital signal received from equalizer 40. More specifically, the analog signal received by transmission/reception unit 21 from other signal transmission apparatus 201 may include a reflected signal caused by reflection of the analog signal transmitted from transmission/reception unit 21 to other signal transmission apparatus 201. For example, echo canceller 50 generates a cancel signal by using the digital signal received from processing unit 24, and corrects the signal waveform represented by the digital signal received from equalizer 40 by using the generated cancel signal in order to reduce the influence of the reflected signal in the analog signal received by transmission/reception unit 21. Echo canceller 50 outputs the corrected digital signal to processing unit 24. Details of echo canceller 50 will be described later.

Processing unit 24 receives the digital signal from echo canceller 50, and performs predetermined processing by using the received digital signal.

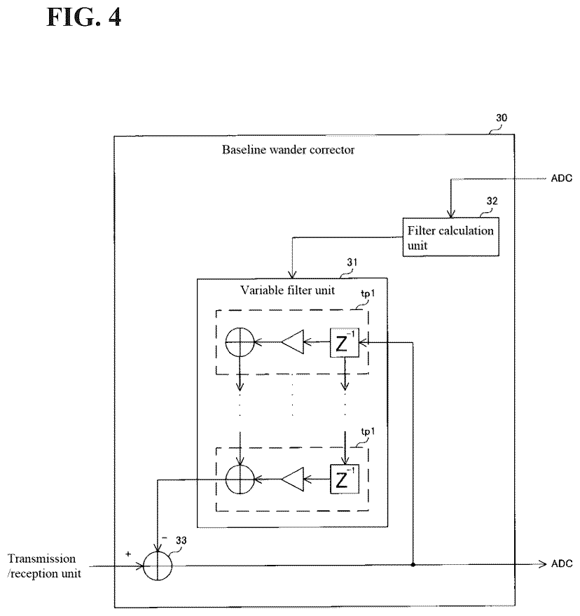

FIG. 4 is a diagram showing an example of a configuration of a baseline wander corrector in a signal transmission apparatus according to an embodiment of the present disclosure. Referring to FIG. 4, baseline wander corrector 30 includes a variable filter unit 31, a filter calculation unit 32, and a subtractor 33. Variable filter unit 31 has L taps tp1. L is an integer of 2 or more. Hereinafter, the filter coefficient of tap tp1 in variable filter unit 31 is also referred to as “filter coefficient h1”, and filter coefficient h1 of tap tp1 in the x-th stage in variable filter unit 31 is also referred to as “filter coefficient h1x”. “x” is an integer of 1 to L.

Subtractor 33 receives the analog signal from transmission/reception unit 21. As will be described later, subtractor 33 receives the analog signal output from variable filter unit 31. Subtractor 33 performs a subtraction process of subtracting the analog signal received from variable filter unit 31 from the analog signal received from transmission/reception unit 21, and outputs the analog signal after the subtraction process to ADC 22 and variable filter unit 31 as a corrected analog signal.

Variable filter unit 31 receives the analog signal from subtractor 33, filters the received analog signal, and outputs the filtered analog signal to subtractor 33.

Filter calculation unit 32 receives the digital signal from ADC 22 and sets filter coefficient h1 of each tap tp1 in variable filter unit 31 by using the received digital signal as a reference signal. More specifically, filter calculation unit 32 updates filter coefficient h1 of each tap tp1 in variable filter unit 31 at the update timing according to a predetermined period T1, so that the level of the DC component of the signal waveform represented by the digital signal received from ADC 22 approaches a predetermined target value.

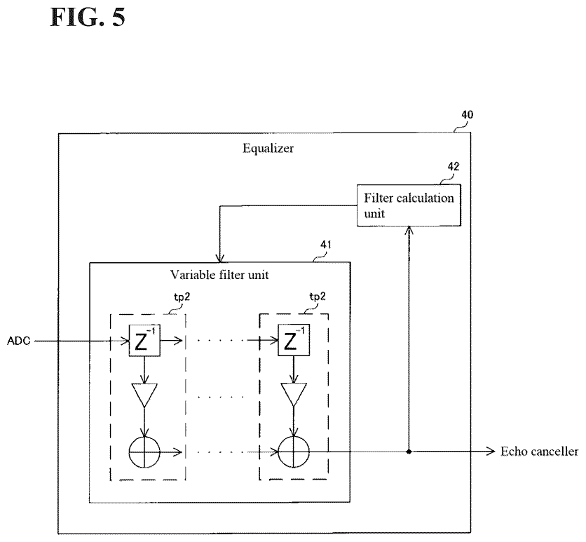

FIG. 5 is a diagram showing an example of a configuration of an equalizer in the signal transmission apparatus according to an embodiment of the present disclosure. Referring to FIG. 5, equalizer 40 includes a variable filter unit 41 and a filter calculation unit 42. Variable filter unit 41 has M taps tp2. M is an integer of 2 or more. Hereinafter, the filter coefficient of tap tp2 in variable filter unit 41 is also referred to as “filter coefficient h2”, and filter coefficient h2 of tap tp2 in the y-th stage in variable filter unit 41 is also referred to as “filter coefficient h2y”. “y” is an integer of 1 to M.

Variable filter unit 41 receives the digital signal from ADC 22, filters a signal waveform represented by the received digital signal, and outputs the filtered digital signal to echo canceller 50 and filter calculation unit 42 as a corrected digital signal.

Filter calculation unit 42 receives the digital signal from variable filter unit 41 and sets filter coefficient h2 of each tap tp2 in variable filter unit 41 by using the received digital signal as a reference signal. More specifically, filter calculation unit 42 updates filter coefficient h2 of each tap tp2 in variable filter unit 41 at the update timing according to period T1, so that the level of the high frequency band of the signal waveform represented by the digital signal received from variable filter unit 41 approaches a predetermined target value.

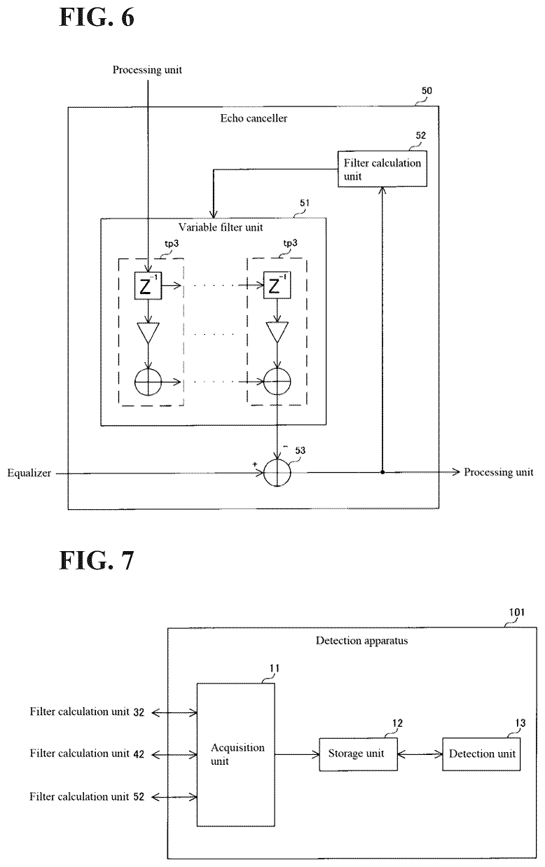

FIG. 6 is a diagram showing an example of a configuration of an echo canceller in the signal transmission apparatus according to an embodiment of the present disclosure. Referring to FIG. 6, echo canceller 50 includes a variable filter unit 51, a filter calculation unit 52, and a subtractor 53. Variable filter unit 51 has N taps tp3. N is an integer of 2 or more. Hereinafter, the filter coefficient of tap tp3 in variable filter unit 51 is also referred to as “filter coefficient h3”, and filter coefficient h3 of tap tp3 in the z-th stage in variable filter unit 41 is also referred to as “filter coefficient h3z”. “z” is an integer of 1 to N.

Subtractor 53 receives the digital signal from equalizer 40. As will be described later, subtractor 53 receives the digital signal output from variable filter unit 51. Subtractor 53 performs a subtraction process of subtracting the signal waveform represented by the digital signal received from variable filter unit 51 from the signal waveform represented by the digital signal received from equalizer 40, and outputs the digital signal after the subtraction process to processing unit 24 and filter calculation unit 52 as a corrected digital signal.

Variable filter unit 51 receives the digital signal from processing unit 24, filters a signal waveform represented by the received digital signal, and outputs the filtered signal waveform to subtractor 53.

Filter calculation unit 52 receives the digital signal from subtractor 53 and sets filter coefficient h3 of each tap tp3 in variable filter unit 51 by using the received digital signal as a reference signal. More specifically, filter calculation unit 52 updates filter coefficient h3 of each tap tp3 in variable filter unit 51 at the update timing according to period T1, so that the level of the component of the reflected signal included in the signal waveform represented by the digital signal received from subtractor 53 approaches a predetermined target value.

### [Detection Apparatus]

FIG. 7 is a diagram showing an example of a configuration of a detection apparatus according to an embodiment of the present disclosure. Referring to FIG. 7, detection apparatus 101 includes an acquisition unit 11, a storage unit 12, and a detection unit 13. Acquisition unit 11 and detection unit 13 are realized by a processor such as a CPU (Central Processing Unit) and a DSP (Digital Signal Processor). Storage unit 12 is, for example, a nonvolatile memory.

### <Acquisition Unit>

Acquisition unit 11 acquires a filter coefficient of the adaptive filter. For example, acquisition unit 11 acquires filter coefficient h1 of baseline wander corrector 30, filter coefficient h2 of equalizer 40, and filter coefficient h3 of echo canceller 50 as the filter coefficients of a plurality of adaptive filters corresponding to single transmission line 1.

For example, acquisition unit 11 acquires filter coefficient h1 of each of L taps tp1 in variable filter unit 31 of baseline wander corrector 30. More specifically, when acquisition unit 11 monitors filter calculation unit 32 in baseline wander corrector 30 and detects that filter coefficient h1 of each tap tp1 is updated by filter calculation unit 32 at the update timing according to period T1, acquisition unit 11 acquires updated filter coefficient h1 of each tap tp1. Acquisition unit 11 stores acquired filter coefficient h1 in storage unit 12.

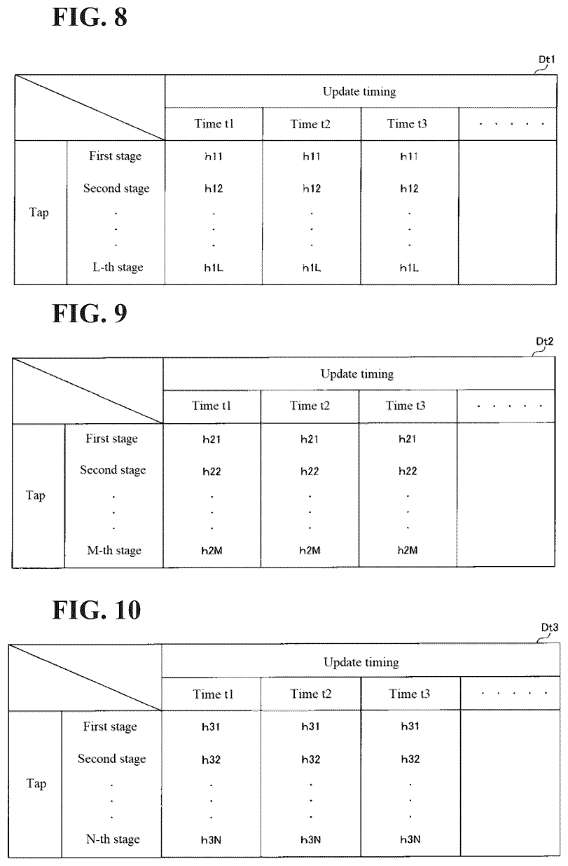

FIG. 8 is a diagram showing an example of time-series data in a storage unit of a detection apparatus according to an embodiment of the present disclosure. FIG. 8 shows a time-series data Dt1 of filter coefficient h1. Referring to FIG. 8, acquisition unit 11 acquires L filter coefficients h11 through h1L from tap tp1 in the first stage through tap tp1 in the L-th stage in variable filter unit 31, and updates time-series data Dt1 by adding acquired filter coefficients h11 through h1L to time-series data Dt1 in storage unit 12 at each update timing of filter coefficient h1.

Also, for example, acquisition unit 11 acquires filter coefficient h2 of each of M taps tp2 in variable filter unit 41 of equalizer 40. More specifically, when acquisition unit 11 monitors filter calculation unit 42 in equalizer 40 and detects that filter coefficient h2 of each tap tp2 is updated by filter calculation unit 42 at the update timing according to period T1, acquisition unit 11 acquires updated filter coefficient h2 of each tap tp2. Acquisition unit 11 stores acquired filter coefficient h2 in storage unit 12.

FIG. 9 is a diagram showing another example of time-series data in a storage unit of a detection apparatus according to an embodiment of the present disclosure. FIG. 9 shows a time-series data Dt2 of filter coefficient h2. Referring to FIG. 9, acquisition unit 11 acquires M filter coefficients h21 through h2M from tap tp2 in the first stage through tap tp2 in the M-th stage in variable filter unit 41, and updates time-series data Dt2 by adding acquired filter coefficients h21 through h2M to time-series data Dt2 in storage unit 12 at each update timing of filter coefficient h2.

Also, for example, acquisition unit 11 acquires filter coefficient h3 of each of N taps tp3 in variable filter unit 51 of echo canceller 50. More specifically, when acquisition unit 11 monitors filter calculation unit 52 in echo canceller 50 and detects that filter coefficient h3 of each tap tp3 is updated by filter calculation unit 52 at the update timing according to period T1, acquisition unit 11 acquires updated filter coefficient h3 of each tap tp3. Acquisition unit 11 stores acquired filter coefficient h3 in storage unit 12.

FIG. 10 is a diagram showing another example of time-series data in a storage unit of a detection apparatus according to an embodiment of the present disclosure. FIG. 10 shows a time-series data Dt3 of filter coefficient h3. Referring to FIG. 10, acquisition unit 11 acquires N filter coefficients h31 through h3N from tap tp3 in the first stage through tap tp3 in the N-th stage in variable filter unit 51, and update time-series data Dt3 by adding acquired filter coefficients h31 through h3N to time-series data Dt3 in storage unit 12 at each update timing of filter coefficient h3. Note that acquisition unit 11 may acquire the filter coefficient of the adaptive filter over time.

### <Detection Unit>

Detection unit 13 performs the detection processing for detecting the abnormality in transmission line 1 based on filter coefficients h1, h2, and h3 acquired by acquisition unit 11. More specifically, when acquisition unit 11 stores filter coefficients h1, h2, and h3 in storage unit 12 at the timing according to period T1, detection unit 13 performs the detection processing based on filter coefficients h1, h2, and h3 stored in storage unit 12.

### Detection Processing by Using Filter Coefficient h1 of Baseline Wander Corrector

### Detection Example 1

When L filter coefficients h1 are stored in storage unit 12 by acquisition unit 11 at the timing according to period T1, detection unit 13 calculates an average value E1 of L filter coefficients h1.

For example, storage unit 12 stores an upper-limit threshold EU1 and a lower-limit threshold EL1 regarding average value E1. Upper-limit threshold EU1 and lower-limit threshold EL1 are preset based on, for example, the distribution of average value E1.

Every time average value E1 is calculated, detection unit 13 compares calculated average value E1 with upper-limit threshold EU1 and lower-limit threshold EL1. If calculated average value E1 is equal to or more than lower-limit threshold EL1 and equal to or less than upper-limit threshold EU1, detection unit 13 determines that the abnormality does not occur in transmission line 1. On the other hand, if calculated average value E1 is less than lower-limit threshold EL1 or more than upper-limit threshold EU1, detection unit 13 determines that the abnormality occurs in transmission line 1.

### Detection Example 2

Detection unit 13 performs the detection processing based on the amount of change over time of filter coefficient h1. For example, detection unit 13 performs the detection processing by comprehensively determining the amount of change over time of L filter coefficients h1 corresponding to L taps tp1 in variable filter unit 31 of baseline wander corrector 30.

More specifically, when time-series data Dt1 is updated by acquisition unit 11 at the timing according to period T1, detection unit 13 calculates an average value A1 of a plurality of filter coefficients h1 corresponding to a plurality of most recent update timings for each tap tp1 in variable filter unit 31. That is, detection unit 13 calculates L average values A1 respectively corresponding to L taps tp1.

Then, detection unit 13 calculates a difference d1 between average value A1 and filter coefficient h1 corresponding to the latest update timing for each tap tp1 in variable filter unit 31. That is, detection unit 13 calculates L differences d1 respectively corresponding to L taps tp1. Detection unit 13 performs the detection processing based on each calculated difference d1.

For example, detection unit 13 can perform both the detection processing based on the amount of change over time of the increasing direction of filter coefficient h1 and the detection processing based on the amount of change over time of the decreasing direction of filter coefficient h1.

More specifically, storage unit 12 stores an abnormality determination condition C1 determined by using the threshold of the amount of change over time of the increasing direction of filter coefficient h1 and the threshold of the amount of change over time of the decreasing direction of filter coefficient h1. Abnormality determination condition C1 is an index for determining whether or not difference d1 is an abnormal value.

Every time L differences d1 are calculated, detection unit 13 counts the number of differences d1 satisfying abnormality determination condition C1 among calculated L differences d1. If the number of differences d1 satisfying abnormality determination condition C1 is the predetermined value or more, detection unit 13 determines that filter coefficient h1 is the abnormal value. On the other hand, if the number of differences d1 satisfying abnormality determination condition C1 is less than the predetermined value, detection unit 13 determines that filter coefficient h1 is a normal value.

That is, in response to determining that filter coefficient h1 is the abnormal value, detection unit 13 determines that the abnormality occurs in transmission line 1.

### Detection Processing by Using Filter Coefficient h2 of Equalizer

### Detection Example 3

When M filter coefficients h2 are stored in storage unit 12 by acquisition unit 11 at the timing according to period T1, detection unit 13 calculates an average value E2 of M filter coefficients h2.

For example, storage unit 12 stores an upper-limit threshold EU2 and a lower-limit threshold EL2 regarding average value E2. Upper-limit threshold EU2 and lower-limit threshold EL2 are preset based on, for example, the distribution of average value E2.

Every time average value E2 is calculated, detection unit 13 compares calculated average value E2 with upper-limit threshold EU2 and lower-limit threshold EL2. If calculated average value E2 is equal to or more than lower-limit threshold EL2 and equal to or less than upper-limit threshold EU2, detection unit 13 determines that the abnormality does not occur in transmission line 1. On the other hand, if calculated average value E2 is less than lower-limit threshold EL2 or more than upper-limit threshold EU2, detection unit 13 determines that the abnormality occurs in transmission line 1.

### Detection Example 4

Detection unit 13 performs the detection processing based on the amount of change over time of filter coefficient h2. For example, detection unit 13 performs the detection processing by comprehensively determining the amount of change over time of M filter coefficients h2 corresponding to M taps tp2 in variable filter unit 41 of equalizer 40.

More specifically, when time-series data Dt2 is updated by acquisition unit 11 at the timing according to period T1, detection unit 13 calculates an average value A2 of a plurality of filter coefficients h2 corresponding to a plurality of most recent update timings for each tap tp2 in variable filter unit 41. That is, detection unit 13 calculates M average values A2 respectively corresponding to M taps tp2.

Then, detection unit 13 calculates a difference d2 between average value A2 and filter coefficient h2 corresponding to the latest update timing for each tap tp2 in variable filter unit 41. That is, detection unit 13 calculates M differences d2 respectively corresponding to M taps tp2. Detection unit 13 performs the detection processing based on each calculated difference d2.

For example, detection unit 13 can perform both the detection processing based on the amount of change over time of the increasing direction of filter coefficient h2 and the detection processing based on the amount of change over time of the decreasing direction of filter coefficient h2.

More specifically, storage unit 12 stores an abnormality determination condition C2 determined by using the threshold of the amount of change over time of the increasing direction of filter coefficient h2 and the threshold of the amount of change over time of the decreasing direction of filter coefficient h2. Abnormality determination condition C2 is an index for determining whether or not difference d2 is an abnormal value.

Every time M differences d2 are calculated, detection unit 13 counts the number of differences d2 satisfying abnormality determination condition C2 among calculated M differences d2. If the number of differences d2 satisfying abnormality determination condition C2 is the predetermined value or more, detection unit 13 determines that filter coefficient h2 is the abnormal value. On the other hand, if the number of differences d2 satisfying abnormality determination condition C2 is less than the predetermined value, detection unit 13 determines that filter coefficient h2 is the normal value.

That is, in response to determining that filter coefficient h2 is the abnormal value, detection unit 13 determines that the abnormality occurs in transmission line 1.

### Detection Processing by Using Filter Coefficient h3 of Echo Canceller

### Detection Example 5

When N filter coefficients h3 are stored in storage unit 12 by acquisition unit 11 at a timing according to period T1, detection unit 13 calculates an average value E3 of N filter coefficients h3.

For example, storage unit 12 stores an upper-limit threshold EU3 and a lower-limit threshold EL3 for average value E3. Upper-limit threshold EU3 and lower-limit threshold EL3 are preset based on, for example, the distribution of average value E3.

Every time average value E3 is calculated, detection unit 13 compares calculated average value E3 with upper-limit threshold EU3 and lower-limit threshold EL3. If calculated average value E3 is equal to or more than lower-limit threshold EL3 and equal to or less than upper-limit threshold EU3, detection unit 13 determines that the abnormality does not occur in transmission line 1. On the other hand, if calculated average value E3 is less than lower-limit threshold EL3 or more than upper-limit threshold EU3, detection unit 13 determines that the abnormality occurs in transmission line 1.

### Detection Example 6

Detection unit 13 performs the detection processing based on the amount of change over time of filter coefficient h3. For example, detection unit 13 performs the detection processing by comprehensively determining the amount of change over time of N filter coefficients h3 corresponding to N taps tp3 in variable filter unit 51 of echo canceller 50.

More specifically, when time-series data Dt3 is updated by acquisition unit 11 at the timing according to period T1, detection unit 13 calculates an average value A3 of a plurality of filter coefficients h3 corresponding to a plurality of most recent update timings for each tap tp3 in variable filter unit 51. That is, detection unit 13 calculates N average values A3 respectively corresponding to N taps tp3.

Then, detection unit 13 calculates a difference d3 between average value A3 and filter coefficient h3 corresponding to the latest update timing for each tap tp3 in variable filter unit 31. That is, detection unit 13 calculates N differences d3 respectively corresponding to N taps tp3. Detection unit 13 performs the detection processing based on each calculated difference d3.

For example, detection unit 13 can perform both the detection processing based on the amount of change over time of the increasing direction of filter coefficient h3 and the detection processing based on the amount of change over time of the decreasing direction of filter coefficient h3.

More specifically, storage unit 12 stores an abnormality determination condition C3 determined by using the threshold of the amount of change over time of the increasing direction of filter coefficient h3 and the threshold of the amount of change over time of the decreasing direction of filter coefficient h3. Abnormality determination condition C3 is an index for determining whether or not difference d3 is an abnormal value.

Every time N differences d3 are calculated, detection unit 13 counts the number of differences d3 satisfying abnormality determination condition C3 among calculated N differences d3. If the number of differences d3 satisfying abnormality determination condition C3 is the predetermined value or more, detection unit 13 determines that filter coefficient h3 is the abnormal value. On the other hand, if the number of differences d3 satisfying abnormality determination condition C3 is less than the predetermined value, detection unit 13 determines that filter coefficient h3 is the normal value.

That is, in response to determining that filter coefficient h3 is the abnormal value, detection unit 13 determines that the abnormality occurs in transmission line 1.

### Detection Processing by Using Filter Coefficients h1, h2, and h3

### Detection Example 7

Detection unit 13 performs the detection processing based on the amount of change over time of filter coefficients h1, h2, and h3 acquired by acquisition unit 11. More specifically, detection unit 13 performs the detection processing by comprehensively determining the amount of change over time of filter coefficients h1, h2, and h3 acquired by acquisition unit 11.

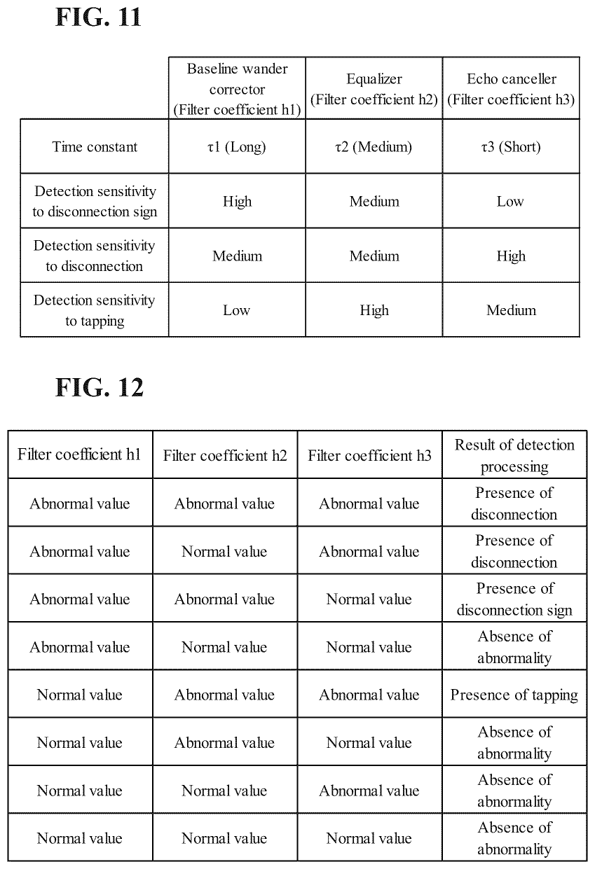

FIG. 11 is a diagram showing a time constant of each variable filter unit and detection sensitivity to various abnormalities in a detection apparatus according to an embodiment of the present disclosure.

Referring to FIG. 11, for example, the time constants of baseline wander corrector 30, equalizer 40 and echo canceller 50 are different from each other. Specifically, among a time constant τ1 of variable filter unit 31 in baseline wander corrector 30, a time constant τ2 of variable filter unit 41 in equalizer 40, and a time constant τ3 of variable filter unit 51 in echo canceller 50, time constant τ1 is the longest, time constant τ2 is the second longest, and time constant τ3 is the shortest.

The detection sensitivity to the disconnection sign of transmission line 1 is the highest in the detection processing by using filter coefficient h1, the second highest in the detection processing by using filter coefficient h2, and the lowest in the detection processing by using filter coefficient h3.

In addition, the detection sensitivity to the disconnection of transmission line 1 is the highest in the detection processing by using filter coefficient h3, and the second highest in the detection processing by using filter coefficients h1 and h2.

In addition, the detection sensitivity to the connection of an other device to transmission line 1, that is, the tapping is highest in the detection processing by using filter coefficient h2, the second highest in the detection processing by using filter coefficient h3, and lowest in the detection processing by using filter coefficient h1.

Detection unit 13 uses the characteristics of the detection sensitivity of the detection processing by using filter coefficients h1, h2, and h3 to determine whether or not the abnormality occurs in transmission line 1 and determine the type of the occurring abnormality, based on the determination result of whether or not filter coefficients h1, h2, and h3 are abnormal values in the above-described detection example 2, 4, 6.

FIG. 12 is a diagram showing a correspondence relationship between the determination result regarding filter coefficients and the result of the detection processing in the detection processing of the detection apparatus according to an embodiment of the present disclosure.

Referring to FIG. 12, for example, in response to determining that filter coefficients h1, h2, and h3 are abnormal values, detection unit 13 determines that disconnection of transmission line 1 occurs.

Further, for example, in response to determining that filter coefficients h1 and h2 are abnormal values and filter coefficient h3 is a normal value, detection unit 13 determines that there is the disconnection sign of transmission line 1.

In addition, for example, in response to determining that filter coefficients h2 and h3 are abnormal values and filter coefficient h1 is a normal value, detection unit 13 determines that the tapping occurs in transmission line 1.

In addition, for example, even if filter coefficient h2 is determined to be an abnormal value, in response to determining that filter coefficients h1 and h3 are normal values, detection unit 13 determines that the abnormality does not occur in transmission line 1. In other words, in response to determining that at least two filter coefficients are determined to have abnormal values among filter coefficients h1, h2 and h3 acquired by acquisition unit 11, detection unit 13 determines that transmission line 1 has the abnormality.

Detection unit 13 may be configured not to perform the detection processing for some of the detection examples 1 to 7.

In response to determining that the abnormality occurs in transmission line 1, detection unit 13 notifies other detection apparatus 101 or an apparatus outside communication system 301 via a transmission line (not shown) of the result of the detection processing. In response to determining that the abnormality occurs in transmission line 1, detection unit 13 may be configured to cut off the connection between signal transmission apparatus 201 and other signal transmission apparatus 201 via transmission line 1 by, for example, performing control to turn off a switch provided in transmission line 1.

### [Operation Flow]

Each device in the communication system according to the embodiment of the present disclosure includes a computer including a memory, and a calculation processing unit such as a CPU in the computer reads a program including a part or all of each step of the following flowchart and sequence from the memory and executes the program. The programs of the plurality of devices can be installed from the outside. The programs of the plurality of devices are distributed in a state of being stored in a recording medium or via a communication line.

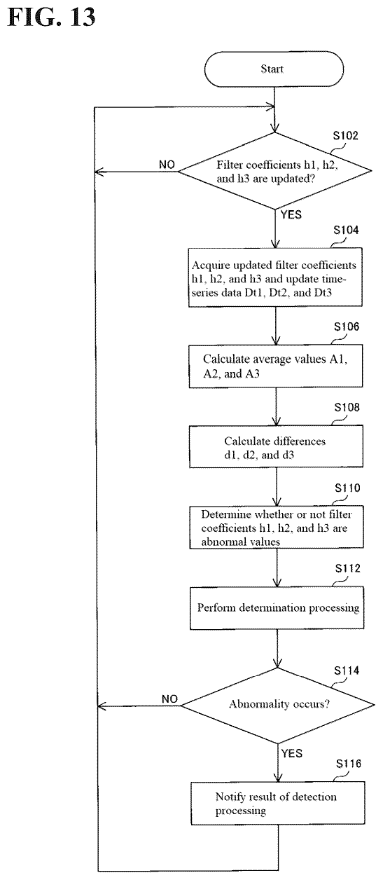

FIG. 13 is a flowchart showing an example of an operation procedure when the detection apparatus according to an embodiment of the present disclosure performs the detection processing. FIG. 13 shows a flowchart of the detection processing of Detection Example 7. In the following description, it is assumed that the number of taps tp1 of variable filter unit 31, the number of taps tp2 of variable filter unit 41, and the number of taps tp3 of variable filter unit 51 are three. Note that the number of taps tp1 of variable filter unit 31, the number of taps tp2 of variable filter unit 41, and the number of taps tp3 of variable filter unit 51 may be 2, or may be 4 or more.

Referring to FIG. 13, detection apparatus 101 monitors filter calculation unit 32 in baseline wander corrector 30, filter calculation unit 42 in equalizer 40, and filter calculation unit 52 in echo canceller 50, waits for, respectively, update of filter coefficients h1, h2, and h3 of taps tp1, tp2, and tp3 in variable filter units 31, 41, 51 (NO in step S102), and when filter coefficients h1, h2, and h3 are updated (YES in step S102), acquires updated filter coefficients h1, h2, and h3. Detection apparatus 101 adds acquired filter coefficients h1, h2, and h3 to time-series data Dt1, Dt2, and Dt3 in storage unit 12 to update time-series data Dt1, Dt2, and Dt3 (step S104).

Next, detection apparatus 101 calculates average values A1, A2, and A3. More specifically, detection apparatus 101 calculates, for each tap tp1, average value A1 of a plurality of filter coefficients h1 corresponding to a plurality of most recent update timings in time-series data Dt1, thereby calculating three average values A1 for each tap tp1. In addition, detection apparatus 101 calculates, for each tap tp2, average value A2 of a plurality of filter coefficients h2 corresponding to a plurality of most recent update timings in time-series data Dt2, thereby calculating three average values A2 for each tap tp2. In addition, detection apparatus 101 calculates, for each tap tp3, average value A3 of a plurality of filter coefficients h3 corresponding to a plurality of most recent update timings in time-series data Dt3, thereby calculating three average values A3 for each tap tp3 (step S106).

Next, detection apparatus 101 calculates differences d1, d2, and d3. More specifically, detection apparatus 101 calculates three differences d1 for each tap tp1 by calculating difference d1 between average value A1 and latest filter coefficient h1 for each tap tp1. In addition, detection apparatus 101 calculates three differences d2 for each tap tp2 by calculating difference d2 between average value A2 and latest filter coefficient h2 for each tap tp2. In addition, detection apparatus 101 calculates three differences d3 for each tap tp3 by calculating difference d3 between average value A3 and latest filter coefficient h3 for each tap tp3 (step S108).

Next, detection apparatus 101 determines whether or not acquired filter coefficients h1, h2, and h3 are abnormal values based on abnormality determination conditions C1, C2, and C3, respectively. More specifically, detection apparatus 101 determines whether or not filter coefficient h1 is an abnormal value according to the number of differences d1 satisfying abnormality determination condition C1 among the calculated three differences d1. In addition, detection apparatus 101 determines whether not filter coefficient h2 is an abnormal value according to the number of differences d2 satisfying abnormality determination condition C2 among the calculated three differences d2. In addition, detection apparatus 101 determines whether or not filter coefficient h3 is an abnormal value according to the number of differences d3 satisfying abnormality determination condition C3 among the calculated three differences d3 (step S110).

Next, detection apparatus 101 performs the detection processing by comprehensively determining the amount of change over time of filter coefficients h1, h2, and h3. More specifically, detection apparatus 101 determines whether or not the abnormality occurs in transmission line 1 and determines the type of the occurring abnormality based on the determination result of whether or not filter coefficients h1, h2, and h3 are abnormal values (step S112).

Next, in response to determining that the abnormality does not occur in transmission line 1 (NO in step S114), detection apparatus 101 waits for the next update of filter coefficients h1, h2, and h3 (NO in step S102).

On the other hand, in response to determining that the abnormality occurs in transmission line 1 (YES in step S114), detection apparatus 101 notifies other detection apparatus 101 or a device outside communication system 301 of the result of the detection processing (step S116).

Next, detection apparatus 101 waits for the next update of filter coefficients h1, h2, and h3 (NO in step S102).

In communication systems 301 and 302 according to the embodiment of the present disclosure, signal transmission apparatus 201 includes baseline wander corrector 30, equalizer 40, and echo canceller 50, but the configuration is not limited thereto. Signal transmission apparatus 201 may include an other adaptive filter instead of some or all of baseline wander corrector 30, equalizer 40, and echo canceller 50, or may include an other adaptive filter in addition to baseline wander corrector 30, equalizer 40, and echo canceller 50. For example, signal transmission apparatus 201 includes, as an other adaptive filter, a crosstalk canceller for removing an induced signal of an electromagnetic wave of a digital signal output from other adjacent communication system 301 and 302. In this case, acquisition unit 11 in detection apparatus 101 may be configured to acquire the filter coefficient of the crosstalk canceller.

In addition, signal transmission apparatus 201 according to the embodiment of the present disclosure includes transmission/reception unit 21, but the configuration is not limited thereto. Signal transmission apparatus 201 may include a reception unit instead of transmission/reception unit 21. That is, signal transmission apparatus 201 may be configured to receive the analog signal from other signal transmission apparatus 201 via transmission line 1 and not to transmit the analog signal to other signal transmission apparatus 201.

In addition, in signal transmission apparatus 201 according to the embodiment of the present disclosure, time constant ti of variable filter unit 31 in baseline wander corrector 30, time constant r2 of variable filter unit 41 in equalizer 40, and time constant r3 of variable filter unit 51 in echo canceller 50 are configured to be different from each other, but the configuration is not limited thereto. Some or all of time constants T1, r2, and r3 may have the same value.

In addition, in detection apparatus 101 according to the embodiment of the present disclosure, acquisition unit 11 is configured to acquire filter coefficients h1, h2, and h3, but the configuration is not limited thereto. Acquisition unit 11 may be configured to acquire any one or two filter coefficients among filter coefficients h1, h2, and h3. In this case, detection unit 13 performs the detection processing based on the amount of change over time of the filter coefficient acquired by acquisition unit 11.

In addition, in detection apparatus 101 according to the embodiment of the present disclosure, acquisition unit 11 is configured to acquire, respectively, filter coefficients h1 of the L taps tp1 in variable filter unit 31 of baseline wander corrector 30, but the configuration is not limited thereto. Acquisition unit 11 may be configured to acquire filter coefficient h1 of tap tp1 of a part among L taps tp1. For example, acquisition unit 11 acquires filter coefficient h1 of any one tap tp1 among L taps tp1. In this case, detection unit 13 performs the detection processing based on the amount of change over time of filter coefficient h1 of tap tp1.

Similarly, acquisition unit 11 may be configured to acquire filter coefficient h2 of tap tp2 of a part among M taps tp2. For example, acquisition unit 11 acquires filter coefficient h2 of any one tap tp2 among M taps tp2. In this case, detection unit 13 performs the detection processing based on the amount of change over time of filter coefficient h2 of tap tp2. In addition, acquisition unit 11 may be configured to acquire filter coefficient h3 of tap tp3 of a part among N taps tp3. For example, acquisition unit 11 acquires filter coefficient h3 of any one tap tp3 among N taps tp3. In this case, detection unit 13 performs the detection processing based on the amount of change over time of filter coefficient h3 of tap tp3.

Also, for example, acquisition unit 11 acquires filter coefficient h1 of any one tap tp1 among L taps tp1, filter coefficient h2 of any one tap tp2 among M taps tp2, and filter coefficient h3 of any one tap tp3 among N taps tp3. In this case, detection unit 13 performs the detection processing by comprehensively determining the amount of change over time of filter coefficient h1 of tap tp1, the amount of change over time of filter coefficient h2 of tap tp2, and the amount of change over time of filter coefficient h3 of tap tp3.

In addition, in detection apparatus 101 according to the embodiment of the present disclosure, detection unit 13 is configured to perform the detection processing by using abnormality determination condition C1 determined by using the threshold of the amount of change over time in the increasing direction of filter coefficient h1 and the threshold of the amount of change over time in the decreasing direction of filter coefficient h1, but the present disclosure is not limited thereto. Without using abnormality determination condition C1, detection unit 13 may be configured to statistically analyze each calculated difference d1 and perform the detection processing based on the analysis result.

Similarly, without using abnormality determination condition C2, detection unit 13 may be configured to statistically analyze each calculated difference d2, and perform the detection processing based on the analysis result. In addition, without using abnormality determination condition C3, detection unit 13 may be configured to statistically analyze each calculated difference d3, and perform the detection processing based on the analysis result.

Meanwhile, a technology capable of more accurately detecting the abnormality in a transmission line is desired. The technology described in PTL 1 detects the frequency of occurrence of instantaneous disconnection in a transmission line based on the frequency at which a filter coefficient determined by an echo canceller becomes a constant value, and the method described in PTL 1 may fail to accurately detect the abnormality in the transmission line. A technology capable of detecting the abnormality in a transmission line more accurately than the technology described in PTL 1 is desired.

On the other hand, detection apparatus 101 of the present disclosure is the detection apparatus provided for signal transmission apparatus 201 that is configured to receive a reception signal via transmission line 1 and include an adaptive filter to be applied to the reception signal. Acquisition unit 11 acquires a filter coefficient of the adaptive filter. Detection unit 13 detects the abnormality in transmission line 1 based on the amount of change over time of the filter coefficient acquired by acquisition unit 11.

With these configurations, it is possible to detect the abnormality in transmission line 1 based on the amount of change over time (tendency of change) of the filter coefficient, and thus it is possible to detect the abnormality in transmission line 1 early and accurately even in a case where the change of the filter coefficient is minute, compared to a configuration in which the temporal change of the filter coefficient is simply used. Therefore, the abnormality in transmission line 1 can be detected more accurately.

It should be understood that the above-described embodiments are illustrative in all respects and are not restrictive. The scope of the present invention is defined not by the above description but by the claims, and is intended to include all modifications within the meaning and scope equivalent to the claims.

The above description includes the following additional features.

### Supplementary Note 1

A detection apparatus is provided for a signal transmission apparatus, the signal transmission apparatus being configured to receive a reception signal via a transmission line and including an adaptive filter to be applied to the reception signal. The detection apparatus includes an acquisition unit configured to acquire a filter coefficient of the adaptive filter, and a detection unit configured to detect an abnormality in the transmission line, based on an amount of change over time in the filter coefficient acquired by the acquisition unit. The acquisition unit is configured to acquire filter coefficients of a plurality of adaptive filters for a single transmission line. The filter coefficient is one of the filter coefficients. The adaptive filter is one of the plurality of adaptive filters. The single transmission line is the transmission line. The detection unit is configured to detect an abnormality in the transmission line, based on an amount of change over time in each of the filter coefficients acquired by the acquisition unit. The detection unit is configured to determine whether the abnormality occurs in the transmission line, and determine a type of the occurring abnormality.

### REFERENCE SIGNS LIST

1 transmission line
1A cable portion
1B connector portion
11 acquisition unit
12 storage unit
13 detection unit
21 transmission/reception unit
22 ADC
23 DAC
24 processing unit
30 baseline wander corrector
31, 41, 51 variable filter unit
32, 42, 52 filter calculation unit
33, 53 subtractor
40 equalizer
50 echo canceller
101 detection apparatus
201 signal transmission apparatus
301, 302 communication system
R1, R2 terminal resistor
tp1, tp2, tp3 tap

1. A detection apparatus provided for a signal transmission apparatus, the signal transmission apparatus being configured to receive a reception signal via a transmission line and including an adaptive filter to be applied to the reception signal, the detection apparatus comprising:
an acquisition circuit configured to acquire a filter coefficient of the adaptive filter; and
a detection circuit configured to detect an abnormality in the transmission line, based on an amount of change over time in the filter coefficient acquired by the acquisition circuit.

2. The detection apparatus according to claim 1, wherein
the acquisition circuit is configured to acquire filter coefficients of a plurality of adaptive filters for a single transmission line, the filter coefficient being one of the filter coefficients, the adaptive filter being one of the plurality of adaptive filters, the single transmission line being the transmission line, and
the detection circuit is configured to detect an abnormality in the transmission line, based on an amount of change over time in each of the filter coefficients acquired by the acquisition circuit.

3. The detection apparatus according to claim 2, wherein the plurality of adaptive filters have time constants different from each other.

4. The detection apparatus according to claim 1, wherein
the acquisition circuit is configured to acquire filter coefficients of a plurality of taps, of the adaptive filter, for a single transmission line, the filter coefficient being one of the filter coefficients, the single transmission line being the transmission line, and
the detection circuit is configured to detect an abnormality in the transmission line, based on an amount of change over time in each of the filter coefficients acquired by the acquisition circuit.

5. The detection apparatus according to claim 1, wherein the detection circuit is configured to perform both detection of an abnormality in the transmission line based on an amount of change over time in the filter coefficient in an increasing direction and detection of an abnormality in the transmission line based on an amount of change over time in the filter coefficient in a decreasing direction.

6. The detection apparatus according to claim 1, wherein the acquisition circuit is configured to acquire, as the filter coefficient of the adaptive filter, a filter coefficient of at least one of a baseline wander corrector, an equalizer, and an echo canceller.

7. The detection apparatus according to claim 2, wherein the acquisition circuit is configured to acquire, as the filter coefficients of the plurality of adaptive filters, three filter coefficients of a baseline wander corrector, an equalizer, and an echo canceller.

8. The detection apparatus according to claim 7, wherein the detection circuit is configured to determine that the transmission line has an abnormality in response to determining that at least two filter coefficients are determined to have abnormal values among the three filter coefficients acquired by the acquisition circuit.

9. The detection apparatus according to claim 1, wherein the detection circuit is configured to determine that the transmission line is abnormal if the number of differences satisfying an abnormality determination condition is a predetermined value or more, and determine that the transmission line is normal if the number of differences satisfying the abnormality determination condition is less than the predetermined value, and
the abnormality determination condition is determined using a threshold for the amount of change over time.

10. A detection method in a detection apparatus provided for a signal transmission apparatus, the signal transmission apparatus being configured to receive a reception signal via a transmission line and including an adaptive filter to be applied to the reception signal, the detection method comprising:
acquiring a filter coefficient of the adaptive filter; and
detecting an abnormality in the transmission line, based on an amount of change over time in the acquired filter coefficient.

11. A recording medium in which a detection program used in a detection apparatus provided for a signal transmission apparatus is stored, the signal transmission apparatus being configured to receive a reception signal via a transmission line and including an adaptive filter to be applied to the reception signal, the detection program causing a computer to function as:
an acquisition circuit configured to acquire a filter coefficient of the adaptive filter; and
a detection circuit configured to detect an abnormality in the transmission line, based on an amount of change over time in the filter coefficient acquired by the acquisition circuit.

12. The detection apparatus according to claim 2, wherein
the acquisition circuit is configured to acquire filter coefficients of a plurality of taps, of the adaptive filter, for a single transmission line, the filter coefficient being one of the filter coefficients, the single transmission line being the transmission line, and
the detection circuit is configured to detect an abnormality in the transmission line, based on an amount of change over time in each of the filter coefficients acquired by the acquisition circuit.

13. The detection apparatus according to claim 3, wherein
the acquisition circuit is configured to acquire filter coefficients of a plurality of taps, of the adaptive filter, for a single transmission line, the filter coefficient being one of the filter coefficients, the single transmission line being the transmission line, and
the detection circuit is configured to detect an abnormality in the transmission line, based on an amount of change over time in each of the filter coefficients acquired by the acquisition circuit.

14. The detection apparatus according to claim 2, wherein the detection circuit is configured to perform both detection of an abnormality in the transmission line based on an amount of change over time in the filter coefficient in an increasing direction and detection of an abnormality in the transmission line based on an amount of change over time in the filter coefficient in a decreasing direction.

15. The detection apparatus according to claim 3, wherein the detection circuit is configured to perform both detection of an abnormality in the transmission line based on an amount of change over time in the filter coefficient in an increasing direction and detection of an abnormality in the transmission line based on an amount of change over time in the filter coefficient in a decreasing direction.

16. The detection apparatus according to claim 4, wherein the detection circuit is configured to perform both detection of an abnormality in the transmission line based on an amount of change over time in the filter coefficient in an increasing direction and detection of an abnormality in the transmission line based on an amount of change over time in the filter coefficient in a decreasing direction.

17. The detection apparatus according to claim 2, wherein the acquisition circuit is configured to acquire, as the filter coefficient of the adaptive filter, a filter coefficient of at least one of a baseline wander corrector, an equalizer, and an echo canceller.

18. The detection apparatus according to claim 3, wherein the acquisition circuit is configured to acquire, as the filter coefficient of the adaptive filter, a filter coefficient of at least one of a baseline wander corrector, an equalizer, and an echo canceller.

19. The detection apparatus according to claim 4, wherein the acquisition circuit is configured to acquire, as the filter coefficient of the adaptive filter, a filter coefficient of at least one of a baseline wander corrector, an equalizer, and an echo canceller.

20. The detection apparatus according to claim 5, wherein the acquisition circuit is configured to acquire, as the filter coefficient of the adaptive filter, a filter coefficient of at least one of a baseline wander corrector, an equalizer, and an echo canceller.
